(19) United States
(12) Patent Application Publication
(10) Pub. No.: US 2012/0284021 A1
(43) Pub. Date: Nov. 8, 2012

(54) CONCEALING AUDIO INTERRUPTIONS

(75) Inventor: Gilles Miet, Antibes (FR)

(73) Assignee: NVIDIA TECHNOLOGY UK LIMITED, London, UK (UK)

(21) Appl. No.: 13/511,880

(22) PCT Filed: Oct. 25, 2010
(86) PCT No.: PCT/EP2010/066069

§ 371 Date: May 24, 2012

(30) Foreign Application Priority Data
Nov. 26, 2009 (GB) 0920729.1

(51) Int. Cl. G10L 19/00

(52) U.S. Cl. 704/225; 704/E19.001

(57) ABSTRACT

A method of processing an audio signal in a communications network, the method comprising: receiving, at a speech buffer, a first portion of the audio signal over the network from a base station of the network, the speech buffer being configured to store and subsequently output the first portion of the audio signal; determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer; in the event that the presence of the interruption has been determined, appending a second portion of the audio signal to the first portion in such a way as to form an output audio signal having no signal discontinuities in the time domain, the second portion having a predetermined duration and having a pitch matching that of the first portion over the predetermined duration; applying a fade out envelope to the second portion to gradually reduce the amplitude of the second portion over the predetermined duration; and outputting the output audio signal.

### FIELD OF THE INVENTION

This invention relates to signal processing, and in particular to processing of an audio signal in a communications network.

### BACKGROUND

In a mobile telecommunications network (such as a GSM or 3G network), a user terminal typically communicates with at least one base station in the network. In this way signals can be sent between the user terminal and the base station(s). Each base station in the network is associated with a geographical region, known as a cell, whereby the base station is used to communicate with user terminals within the particular cell associated with the base station. When a user of the user terminal takes the user terminal from one cell to another a handover is performed in which the user terminal stops communicating with a first base station and starts communicating with a second base station.

During a voice call over the network there is a need to maintain continuous communication between the user terminal and a base station to ensure that the voice call is not interrupted. If a handover occurs during a voice call the audio stream can be interrupted for a short duration while the handover process is performed. This interruption can cause sounds that are undesirable from the user's perspective and give an impression of bad audio quality.

Efforts have been made in the prior art to address the problem of interrupting a voice call during handover. For example, in WO 1998/009454 by Khawand et al, handovers between base stations are performed where possible during periods in which there is no voice activity in the signal. In this way, the handover is performed when the users in the voice call are not talking. Similar systems are described in WO 99/65266 by Cerwall and in GB 2330484 by Frandsen. In these systems the detection of voice pauses to trigger the handover can be complex, requiring significant use of processing resources. Furthermore, these systems rely on there being a period of speech inactivity at or near the time when handover is required.

Other prior art systems use artificial comfort noise synthesis in which a handover period is filled with artificially created noise. Such systems are described in US 2008/0002620A1 by Anderton et al and in U.S. Pat. No. 5,974,374 by Wake. However, the use of comfort noise is not always appropriate, in particular when voiced speech, such as a vowel, is interrupted by the handover.

Another method employed in the prior art is to repeat and fade out buffered received speech at the user terminal to cover the interruption caused by the handover. However, this method typically creates audible clicks in the signal due to signal discontinuity as the speech is repeated. The human ear is particularly sensitive to signal discontinuities in a speech signal. A sudden discontinuity in the speech signal (such as an artificial jump in the signal between one speech sample and the next or a sudden mute) often creates a “click” sound, which may be perceived by the user as bad audio quality in the signal.

There is therefore a problem in the prior art of how to improve the quality of an audio signal when the audio signal is interrupted during handover between base stations in a communications network.

### SUMMARY

According to a first aspect of the invention there is provided a method of processing an audio signal in a communications network, the method comprising: receiving, at a speech buffer, a first portion of the audio signal over the network from a base station of the network, the speech buffer being configured to store and subsequently output the first portion of the audio signal; determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer; in the event that the presence of the interruption has been determined, appending a second portion of the audio signal to the first portion in such a way as to form an output audio signal having no signal discontinuities in the time domain, the second portion having a predetermined duration and having a pitch matching that of the first portion over the predetermined duration; applying a fade out envelope to the second portion to gradually reduce the amplitude of the second portion over the predetermined duration; and outputting the output audio signal.

According to a second aspect of the invention there is provided an apparatus for processing an audio signal in a communications network, the apparatus comprising: a speech buffer for receiving a first portion of the audio signal over the network from a base station of the network, the speech buffer being configured to store and subsequently output the first portion of the audio signal; means for determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer; means for appending a second portion of the audio signal to the first portion in the event that the presence of the interruption has been determined, in such a way as to form an output audio signal having no signal discontinuities in the time domain, the second portion having a predetermined duration and having a pitch matching that of the first portion over the predetermined duration; means for applying a fade out envelope to the second portion to gradually reduce the amplitude of the second portion over the predetermined duration; and means for outputting the output audio signal.

According to a third aspect of the invention there is provided a system for processing an audio signal, the system comprising: a communications network comprising a base station for transmitting the audio signal; and an apparatus as described above for receiving and processing the audio signal.

In a fourth aspect of the invention there is provided a computer program product comprising computer readable instructions for performing a method as described above.

Prior art systems require notification in advance of a handover that the handover will happen shortly. This allows the systems to prepare for the interruption to the audio signal caused by the handover. The prior art systems are not adapted for use where there is no advance notification that the audio signal will be interrupted. For example these prior art systems cannot handle unexpected speech underflow in which the speech buffer at the user terminal does not receive audio signal quickly enough, resulting in the speech buffer running out of audio signal to output. This may be due to the system not transmitting the signal for a period of time or may be due to a loss of synchronization between the user terminal and the base station without notification.

In preferred embodiments, a recovery buffer stores a copy of a portion of the most recently received speech frame of the audio signal. The pitch period of the frame is determined so that the copied portion in the recovery buffer can be time shifted to ensure continuity of the signal characteristics with the most recently received speech frame. When the audio signal is unvoiced, any reasonable time shift, or alternatively no time shift, can be applied to the copied portion in the recovery buffer. The copied portion in the recovery buffer can then be appended to the most recently received frame in the speech buffer to create a continuous signal. Since the copied portion is copied from the most recently received speech frame in the speech buffer, the copied portion has a matching spectral profile to that of the frame in the speech buffer. Consequently, the evolution over time of important characteristics of the speech signal (such as the signal in the time domain, the signal level, the pitch and the spectral shape) is ensured to be continuous from the most recently received frame in the speech buffer onward to the end of the recovery buffer, without any sudden changes.

Therefore when the copied portion is appended to the frame in the speech buffer the result is a natural sounding continuous audio signal. By using the recovery buffer it can be ensured that there is sufficient continuous audio signal available to be output for a predetermined duration D. A fade out pattern can be applied to the audio signal for the predetermined duration D to fade out the audio signal in a natural sounding way.

In preferred embodiments, audio stream interruption situations (such as handover or sudden underflow) are handled quickly and seamlessly. A natural sounding fading out of the audio stream is provided even when the speech buffer is empty. As stated above, the human ear is particularly sensitive to signal discontinuities and fading-out speed in a speech signal. The smooth and progressive fading out of the audio signal provided by preferred embodiments is comfortable for the user. Preferably the audio signal is faded out over a duration in the order of 3-20 ms which is comfortable for the user and is sufficiently short to allow the system to resume from the interruption quickly. Thus, the present invention produces a continuous, quickly faded-out speech signal without any artefacts. Longer durations, such as 20-200 ms are possible but increasing the fade out duration D into this longer range does not significantly improve the quality of the audio signal and may give the impression of muted transmission.

The present invention offers a solution that improves the perception of speech quality in the case of underflow or handover. The solution is cheap and efficient in terms of processing power, it does not create signal artefacts and so the audio signal sounds natural to the user and it does not add delay in the system.

### BRIEF DESCRIPTION OF THE DRAWINGS

For a better understanding of the present invention and to show how the same may be put into effect, reference will now be made, by way of example, to the following drawings in which:

FIG. 1 is a schematic diagram of a communications system according to a preferred embodiment;

FIG. 2 is a flow chart of a process of processing an audio signal according to a preferred embodiment;

FIG. 3 is a representation of a frame of an audio signal;

FIGS. 4a and 4b are diagrams showing the copying of a portion of the audio signal according to a two different embodiments;

FIGS. 5a to 5c are diagrams showing the selection of a portion of audio signal is three different conditions;

FIG. 6 is a diagram representing the application of a fade out envelope to the audio signal;

FIG. 7 is a diagram representing the signal after the fade out envelope has been applied;

FIGS. 8a to 8c represent the audio signal according to three different prior art methods;

FIG. 9 shows an audio signal which is faded out and faded back in;

FIG. 10 describes a simple technique, as an example to compute the pitch; and

FIG. 11 illustrates the continuity of speech characteristics between the last received speech frame and the recovery buffer.

### DETAILED DESCRIPTION OF PREFERRED EMBODIMENTS

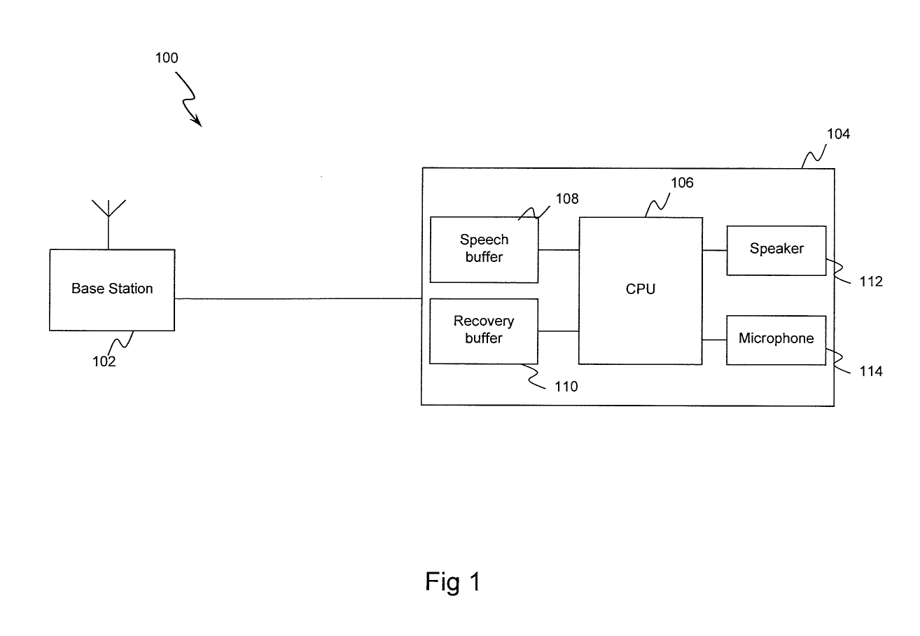

With reference to FIG. 1 there is now described a communications system 100 according to a preferred embodiment of the present invention. The communications system 100 comprises a base station 102. The communications system 100 comprises more than one base station but only one is shown in FIG. 1 for clarity. The base station 102 has a wireless communication channel for communicating with a user terminal 104. Signals can be transmitted between the base station 102 and the user terminal 104 using any known method, as would be apparent to a skilled person. The user terminal 104 comprises a CPU 106, a speech buffer 108, and recovery buffer 110, a speaker 112 and a microphone 114. The user terminal 104 comprises other components, but only the above mentioned components are shown in FIG. 1 for clarity. The speech buffer 108, recovery buffer 110, speaker 112 and microphone 114 each have a respective connection to the CPU 106. The connections may be direct and/or indirect using peripherals and/or other components (e.g. D/A and A/D converters for audio). The microphone 114 can be used for receiving audio signals from a user of the user terminal 104. The speaker 112 can be used for outputting audio signals to the user.

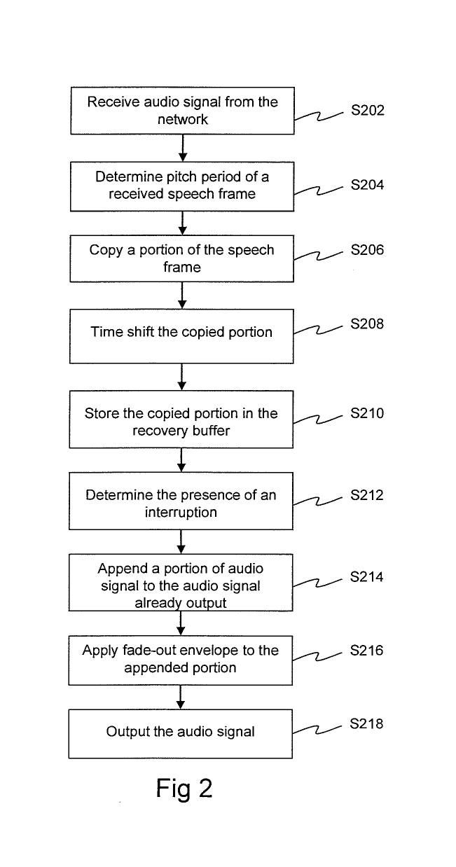

The operation of the communications system 100 in a preferred embodiment will now be described with reference to FIG. 2. In step S202 an audio signal is received at the user terminal 104 from the base station 102 over the communications network. The audio signal is received at the user terminal 104 using an antenna (not shown), the audio signal being received via a wireless link, such as an RF link between the user terminal 104 and the base station 102. The mechanism to receive an RF signal and obtain the audio signal is known in the art and is neither shown in FIG. 1 nor described in FIG. 2 to simplify the presentation. The audio signal is stored in the speech buffer 108. If the audio signal has been encoded for transmission from the base station 102 then the audio signal is decoded before being stored in the speech buffer 108. The audio signals stored in the speech buffer can be output to the user of the user terminal 104 using for example the speaker 112. When the user is engaging in a voice call over the network, the received audio signal is typically output from the speech buffer in real time, such that there is not a significant delay between receiving the audio signal at the user terminal 104 and outputting the audio signal through the speaker 112. This allows a conversation to flow smoothly between users in the voice call, without a user-perceptible delay being added to the signals.

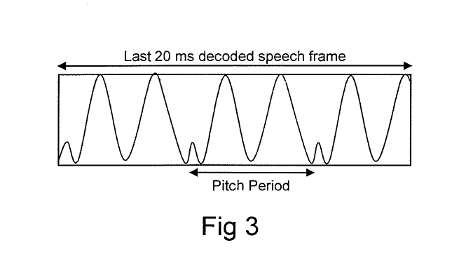

The audio signal typically comprises a plurality of speech frames. In this example, the speech frame and the speech buffer have the same duration (20 ms) which corresponds to the frame length most commonly used in current communication standards. However, different speech frame lengths can be used depending on the communication standard. If speech frames are shorter than this, they can be appended successively to obtain a speech buffer of the desirable length. Similarly, if the frame and the speech buffer are longer, only the last portion of speech buffer can be used to obtain the desirable length. In step S204 a speech frame received at the user terminal 104 is analysed to determine the pitch period of the speech frame. An example of a speech frame is shown in FIG. 3, which indicates the pitch period of the exemplary speech frame. The pitch period is the smallest spacing between two similar portions of voiced speech in the time domain, i.e. the time spacing between two consecutive harmonics in the speech signal short-term spectrum. The pitch corresponds to the invert of the pitch period.

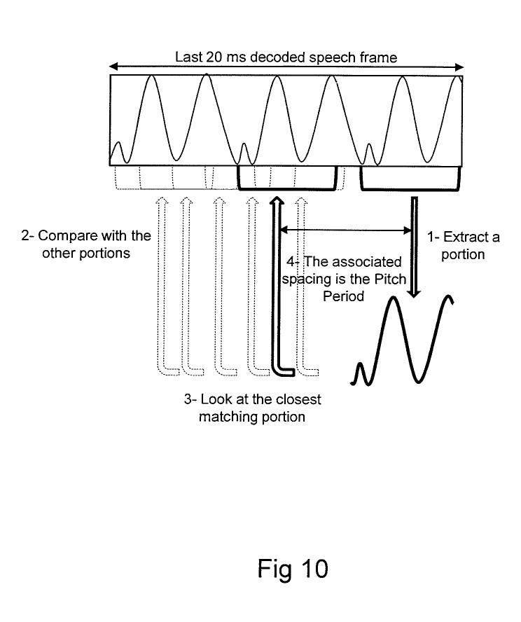

A method to determine the pitch period is illustrated in FIG. 10 in which a simple method based on cross correlation is used. As shown in FIG. 10, the first step of the method is to extract a portion of the most recently received speech frame. The extracted portion is then compared with a number of other portions of the received speech signal that were received at different time spacings before the extracted portion was received. The third step in the method is to find the one of the other portions that most closely matches the extracted portion (e.g. by calculating the correlation between the portions). The time spacing between the extracted portion and the most closely matching previous portion indicates the pitch period of the speech signal. Other methods could be used to determine the pitch as would be apparent to the skilled person.

As in the example shown in FIG. 3 the pitch period of voiced speech is typically shorter than the duration of the speech frame. This means that at least one pitch period of the audio signal will be contained in the speech frame. Optionally, older speech frames or parameters can be used to estimate the pitch period.

In an alternative embodiment the signal received at the user terminal 104 from the base station 102 comprises a pitch period parameter which identifies the pitch period of the frame of the audio signal. Therefore in step S204 the pitch period is determined by using the pitch period parameter received in the audio signal, rather than by performing any signal analysis on the speech frame.

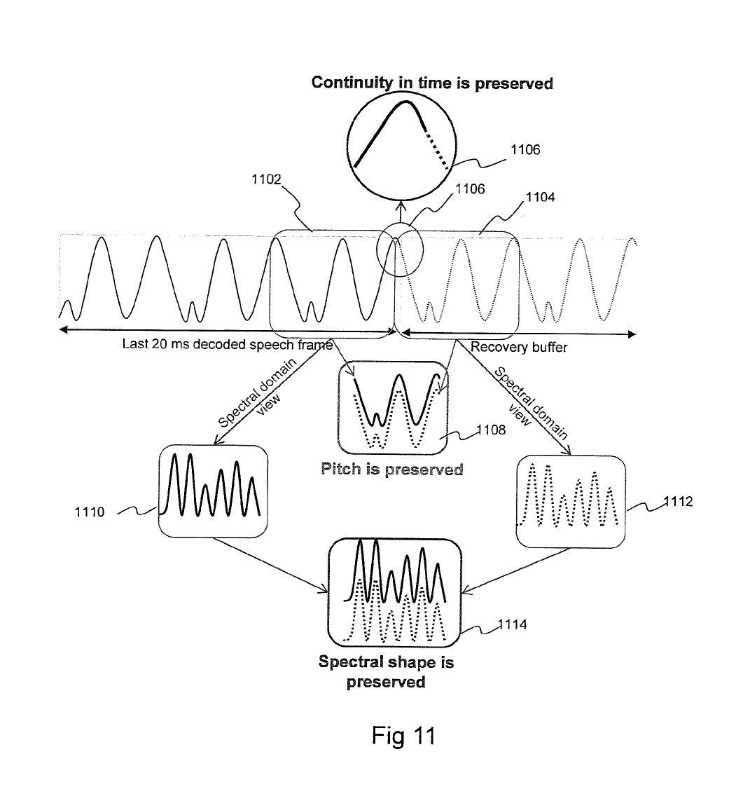

In step S206 a portion of the speech frame is copied. In step S208 the copied portion is time shifted in dependence upon the pitch period determined in step S204. The time shift is selected such that the copied portion can be appended to the speech frame in the speech buffer 108 in such a way that the resulting signal has no discontinuities (i.e. the evolution of the most important signal characteristics is continuous as described below with reference to FIG. 11). When the signal is unvoiced, any reasonable time shift, or alternatively no time shift, can be applied to the copied portion in the recovery buffer. For example if the speech frame ends with the signal at a certain fraction (e.g. ¾) of a cycle through the pitch period, then the copied portion will be time shifted to begin at that certain fraction (e.g. ¾) of a cycle through the pitch period. In this way, a continuous signal from the speech frame onward can be created.

FIG. 11 shows the last frame in the speech buffer and the signal in the recovery buffer. The signal in the recovery buffer is shown as a dotted line to distinguish it from the signal in the speech buffer. The last portion of the speech frame is indicated by numeral 1102 and the first portion in the recovery buffer is indicated by numeral 1104. The enlarged representation of the join between portions 1102 and 1104 is shown in circle 1106. It can be seen that the signal is continuous in the time domain between the speech buffer and the recovery buffer. The box 1108 in FIG. 11 shows the two portions 1102 and 1104 together and it is apparent that the two portions have the same pitch period over the duration of the portions 1102 and 1104. Therefore the pitch of the signal in the recovery buffer matches that of the signal in the speech buffer. The box 1110 shows the portion of the signal in box 1102 in the frequency domain. In other words the box 1110 shows the spectral profile of the last portion of the signal in the speech buffer. Similarly, the box 1112 shows the portion of the signal in box 1104 in the frequency domain. In other words the box 1112 shows the spectral profile of the first portion of the signal in the recovery buffer. The box 1114 shows the two portions 1102 and 1104 together in the frequency domain and it is apparent that the two portions have the same spectral profile. It can also be seen in FIG. 11 that the level of the signal (i.e. the amplitude of the signal) is continuous between the recovery buffer and the speech buffer.

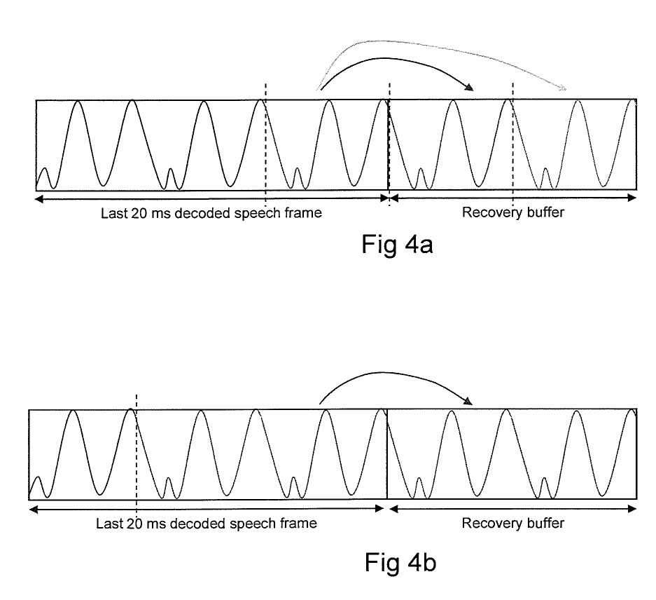

Returning to the method shown in FIG. 2, in step S210 the copied portion is stored in the recovery buffer 110. The duration of the copied portion is at least a predetermined duration D which is used as a fade out duration as described in more detail below. The copied portion may be stored in the recovery buffer 110 in two different ways as shown in FIGS. 4a and 4b respectively.

The first method for storing the copied portion in the recovery buffer 110 is shown in FIG. 4a in which the audio signal in the last pitch period of the speech frame is copied multiple times into the recovery buffer 110 as shown. In FIG. 4a the audio signal in the last pitch period of the speech frame from the speech buffer 108 is copied twice and placed into the recovery buffer 110.

The second method for storing the copied portion in the recovery buffer 110 is shown in FIG. 4b in which the audio signal from multiple pitch periods of the speech frame is copied into the recovery buffer 110 as shown. In FIG. 4b the audio signal in the last two pitch periods of the speech frame is copied from the speech buffer and placed into the recovery buffer 110.

It can be seen that the signal stored in the recovery buffer 110 as a result of either of the methods shown in FIGS. 4a and 4b can be appended to the end of the speech frame in the speech buffer 108 to create a continuous signal (The transition between the signal in the recovery buffer 110 and the speech frame in the speech buffer 108 can be further smoothed by a signal processing technique—some of which are already well known in the art). This is due to the time shifting of the copied portion as described above. The copied portion in the recovery buffer 110 has a duration of at least the predetermined duration D.

In step S212 the presence of an interruption in the audio flow between the base station 102 and the terminal equipment speaker 112 is determined. For example, the interruption may be due to a handover between base stations in the communications network or due to underflow in the receipt of the audio signal from the base station 102 (either attributed to the base station 102 or to the terminal equipment 104 or to the radio link between both). The interruption is such that a portion of the audio signal is output from the speech buffer 108 before a subsequent portion of the audio signal which is intended to be output from the speech buffer immediately following the output of the first portion is stored in the speech buffer. In other words the speech buffer 108 runs out of audio signal to output due to the interruption.

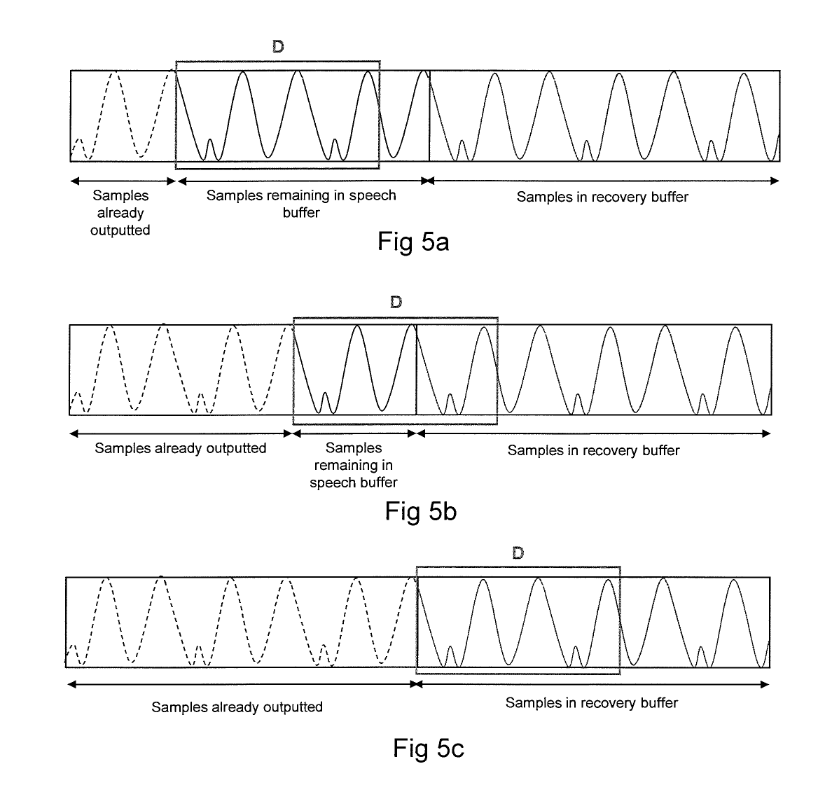

According to the preferred embodiment, when the interruption occurs, a second portion of audio signal of duration D is output from the speaker 112 and the second portion is faded out over the duration D. In order for this to be achieved, in step S214 the second portion of the audio signal is appended to the audio signal already output from the speech buffer 108. This second portion of the audio signal may be obtained from different sources as explained below with reference to FIGS. 5a to 5c. Here also, the transition between the first portion and the second portion of the audio signal can be further smoothed by a signal processing technique.

When the interruption occurs, if the speech buffer 108 has enough audio signal still waiting to be output then the second portion of the audio signal can be obtained entirely from the speech buffer 108. This is shown in FIG. 5a in which there are enough samples in the speech buffer 108 which have not yet been output to take the second portion solely from the speech buffer 108. The square marked with a “D” in FIG. 5a denotes the samples which are to be used as the second portion. The situation shown in FIG. 5a would not happen with a sudden underflow because an underflow indicates that there are not samples in the speech buffer 108 which have not yet been output: underflow indicates that all of the samples have been output from the speech buffer 108.

In other situations, when the interruption occurs the speech buffer 108 may not have enough samples waiting to be output to create the second portion of duration D. In these cases the recovery buffer 110 is used to compensate for the lack of audio signal in the speech buffer 108. For example, FIG. 5b shows the case in which the interruption occurs when some samples remain in the speech buffer 108 but not enough samples remain to create the second portion of duration D. In this case, some of the audio signal stored in the recovery buffer 110 is used as well as the remaining audio signal in the speech buffer 108 as shown in FIG. 5b to create the second portion of duration D. It can be seen that because the audio signal in the recovery buffer 110 is appended to the audio signal in the speech buffer 108 to create a continuous signal the second portion does not contain any signal discontinuities.

In the situation shown in FIG. 5c all of the samples have been output from the speech buffer 108 when the interruption occurs. This corresponds to the case of an interruption caused by underflow (e.g.: a mechanism detects that the speech buffer 108 is empty). The second portion as shown by the square denoted “D” in FIG. 5c is taken entirely from the recovery buffer. As described above, because the audio signal in the recovery buffer 110 is time shifted, the second portion can be output following the audio signal already output from the speech buffer 108 and there will not be any signal discontinuities in the output signal.

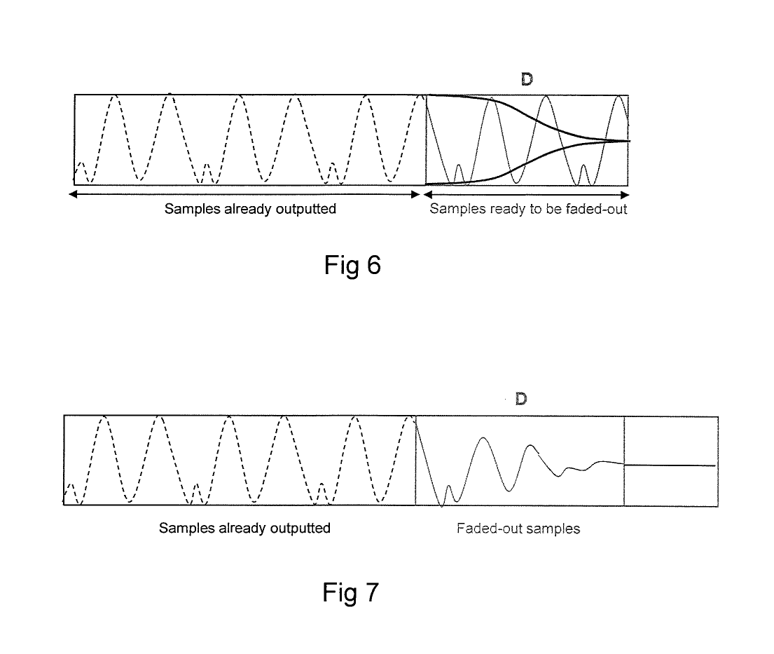

In step S216 a fade-out envelope is applied to the second portion. The fade-out envelope has a duration D. FIG. 6 shows the fade-out envelope which will be applied to the second portion of the audio signal. In the example shown in FIG. 6 the amplitude will be reduced to substantially zero by the end of the duration D. FIG. 7 shows the result of applying the fade-out envelope to the audio signal. It can be seen that the amplitude of the audio signal is faded out over a duration D. Following the faded out signal samples, a period of silence may be used as shown in FIG. 7 until further audio signal samples are received which can be output in the usual manner. Alternatively, a noise signal, such as comfort noise may be generated in the user terminal 104 and output after the faded out signal samples until further audio signal samples are received. Any other type of synthetic signal generated in the user terminal 104 may be output after the faded out signal samples until further audio signal samples are received. Useful synthetic signals include comfort noise as described above and synthetic signals generated by a bad frame handling mechanism as is known in the art. Different synthetic signals may be mixed together and output together until further audio signal samples are received. Depending on the nature of the transmission, the first portion of the further received samples may be faded-in to avoid signal discontinuity (sudden onset that creates a click). This can be done by applying a fade-in envelope (which can be the fadeout envelope time reverted), by resetting the speech decoder, or by doing nothing. In step S218 the audio signal is output from the speaker 112.

In some embodiments, the faded out signal which is output over the duration D is mixed with a noise signal, e.g. comfort noise generated at the user terminal 104. This can give a more natural sounding faded out signal.

The duration D can be a fixed quantity. Alternatively, the duration D can be variable in dependence on, for example, characteristics of the audio signal such as the speech signal content, or characteristics of the user terminal 104 such as the user terminal recovery time capability after an underflow event.

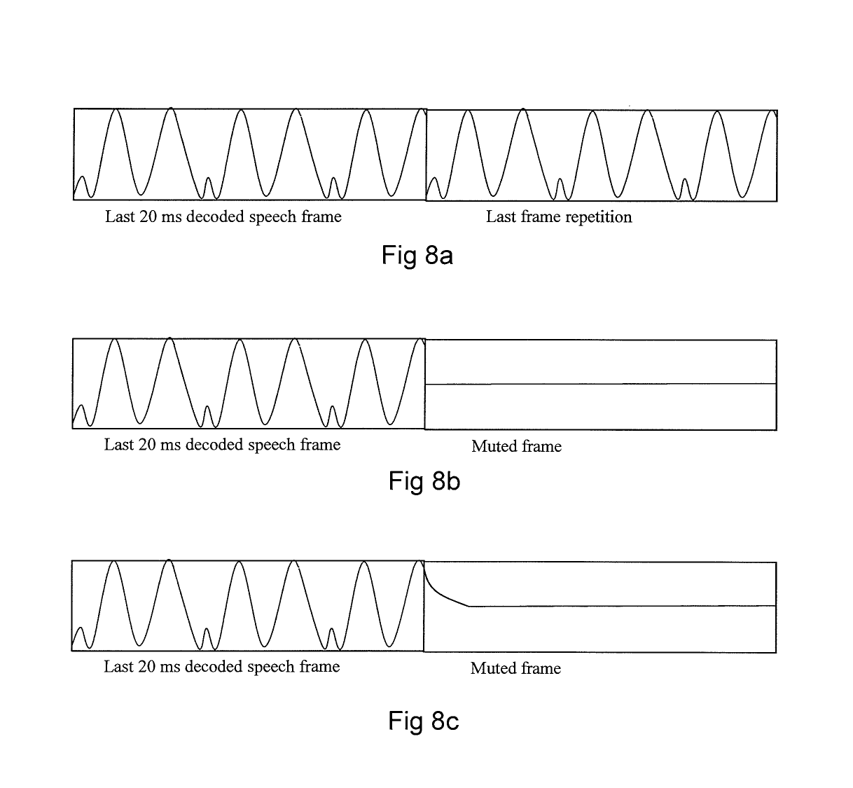

The method described above will create a smooth fading out of the audio signal, in which there are no signal discontinuities in the audio signal. FIGS. 8a to 8c show three alternative methods of handling interruptions to the audio signal. The method of the present invention described above has advantages over all three of the methods shown in FIGS. 8a to 8c as described below.

FIG. 8a shows a method in which the last received speech frame before the interruption is repeated. It can be seen that where the original speech frame joins the repeated speech frame there is a discontinuity in the signal which will create an audible clicking artefact in the output signal which could even create rattle noise if the frame is repeated several times.

FIG. 8b shows a method in which a silence frame is added after the last received speech frame. This creates a signal discontinuity which can create audible artefacts in the audio signal.

The present invention time shifts the audio signal in the recovery buffer 110 according to the pitch period of the audio signal to ensure that there is no signal discontinuity such as that shown in FIGS. 8a and 8b.

FIG. 8c shows a method in which the amplitude of the audio signal is smoothly brought down to zero following an interruption. This is an improvement on the method shown in FIG. 8b, because there are no signal discontinuities, but the spectral profile of the audio signal has a sudden change at the end of the last received speech signal. In other words, the frequency components of the audio signal are suddenly changed which will create an audible artefact in the audio signal.

The present invention is advantageous over the method shown in FIG. 8c because the spectral profile of the second portion matches that of the already output signal. In this way, the frequency components in the output audio signal are not suddenly changed which removes the audible artefacts in the audio signal.

The fading out duration D is preferably in the range 3-20 ms. This is long enough to avoid creating an audible clicking sound in the audio signal, whilst being short enough to allow the system to react quickly to subsequent changes in the network conditions. For example, if the interruption is caused by a handover, the user terminal 104 needs to quickly resume normal operation when audio signals are received from the new base station after handover is complete. Similarly, when an underflow condition is resolved, the user terminal 104 needs to quickly resume normal operation when audio signals are next received.

In the embodiment described above, a copied portion of each speech frame that is received at the speech buffer 108 is stored in the recovery buffer 110. This allows the recovery buffer 110 to be prepared in advance of an interruption, such that when an interruption occurs (even if the interruption occurs with no advance notification such as in the event of a sudden underflow) then the recovery buffer is already prepared to be used in fading out the audio signal as described above. This avoids extra processing power when the interruption occurs.

In alternative embodiments copied portions of received speech frames are only stored in the recovery buffer 110 when an interruption occurs. This is particularly useful when interruptions occur with some advance warning, such as in the case of a network programmed hand-over in which the modem indicates that an audio stream rupture or underflow is about to occur before the underflow actually occurs. In this alternative embodiment, when advance warning of an interruption is received, the step of determining the presence of an interruption (step S212 in FIG. 2) can be performed before the steps S204 to S210.

The present invention avoids audible artefacts in the speech stream without needing to rerun a speech decoder.

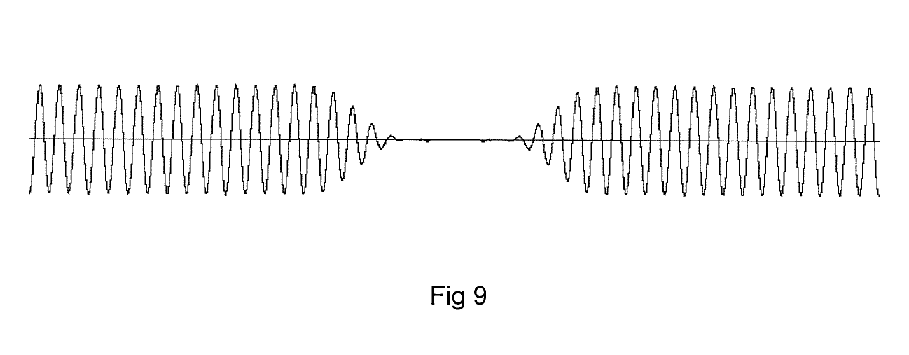

The method described above can be split conceptually into three different steps:
The preparation of the recovery buffer 110 which can be used if there is an interruption to the speech stream;
The detection of an interruption (such as handover or underflow); and
The generation and output of a faded out signal from the user terminal.

Where an interruption occurs causing the signal to be faded out as described above, when the next audio signals are received at the user terminal 104 the amplitude of the output audio signal can be faded in over a duration Dᵢₙ which can be the same as, or different from, the fade out duration D). By fading in the audio signal, a sudden change in the amplitude is avoided which can improve the user's perception of the audio quality. FIG. 9 shows an example of the signal amplitude being faded out and then faded back in according an embodiment of the invention. The faded in signal can be mixed with a noise signal such as comfort noise generated at the user terminal 104 to provided a more natural sounding fading in of the audio signal.

While this invention has been particularly shown and described with reference to preferred embodiments, it will be understood to those skilled in the art that various changes in form and detail may be made without departing from the scope of the invention as defined by the appendant claims.

1-30. (canceled)

31. A method of processing an audio signal in a communications network, the method comprising:
receiving, at a speech buffer, a first portion of the audio signal over the network from a base station of the network, the speech buffer being configured to store and subsequently output the first portion of the audio signal;
determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer;
in the event that the presence of the interruption has been determined, appending a second portion of the audio signal to the first portion in such a way as to form an output audio signal having no signal discontinuities in the time domain, the second portion having a predetermined duration and having a pitch matching that of the first portion over the predetermined duration;
applying a fade out envelope to the second portion to gradually reduce the amplitude of the second portion over the predetermined duration; and
outputting the output audio signal.

32. The method of claim 31 wherein the second portion has a spectral profile matching that of the first portion.

33. The method of claim 31 wherein there are no discontinuities in the amplitude of the output audio signal.

34. The method of claim 31 wherein the amplitude of the second portion is reduced to substantially zero by the end of the predetermined duration.

35. The method of claim 31 wherein the predetermined duration is fixed.

36. The method of claim 31 wherein the predetermined duration is dynamically variable.

37. The method of claim 31 further comprising, following outputting the output signal for the predertermined duration, outputting at least one of a silent signal, a noise signal and a synthetic signal until the interruption finishes.

38. The method of claim 31 further comprising mixing the output audio signal with at least one of a noise signal and a synthetic signal.

39. The method of claim 31 further comprising:
receiving a third portion of the audio signal immediately following the interruption;
applying a fade in envelope to the third portion; and
outputting the third portion.

40. The method of claim 31 further comprising:
storing, at a recovery buffer, a copied portion of the frame of the audio signal that has been received at the speech buffer most recently;
determining the pitch period of the frame; and
applying a time shift to the copied portion in dependence upon the determined pitch period such that the copied portion can be appended to the frame in the speech buffer to create a continuous signal.

41. The method of claim 40 wherein the step of determining the pitch period comprises analysing the frame to calculate the pitch period.

42. The method of claim 40 wherein the step of determining the pitch period comprises receiving a pitch period parameter in the received audio signal which indicates the pitch period of the frame.

43. The method of claim 40 wherein on reception of each frame a copied portion of the audio signal that is received at the speech buffer is stored in the recovery buffer.

44. The method of claim 40 wherein only in the event that the presence of the interruption is determined is a copied portion of a frame of the received audio signal stored in the recovery buffer.

45. The method of claim 40 wherein the duration of the copied portion is greater than or equal to the predetermined duration.

46. The method of claim 40 further comprising:
in the event that the presence of the interruption has been determined, appending the copied portion in the recovery buffer to the frame in the speech buffer to create a continuous recovery signal.

47. The method of claim 46 wherein the transition in the recovery signal between the frame in the speech buffer and the copied portion is smoothed by a signal processing technique.

48. The method of claim 46 wherein at least part of the continuous recovery signal is used as the second portion of the audio signal.

49. The method of claim 48 wherein at least part of the second portion of the audio signal is from the copied portion in the recovery buffer.

50. The method of claim 49 wherein the entire second portion of the audio signal is from the copied portion in the recovery buffer.

51. The method of claim 49 wherein a first part of the second portion of the audio signal is from the speech buffer and a second part of the second portion of the audio signal is from the copied portion in the recovery buffer.

52. The method of claim 31 wherein the second portion of the audio signal is from the speech buffer.

53. The method of claim 31 wherein the transition between the first portion and the second portion is smoothed by a signal processing technique.

54. The method of claim 31 wherein the interruption is caused by underflow in the speech buffer.

55. The method of claim 31 wherein the interruption is caused by a handover between base stations in the communications network.

56. The method of claim 31 wherein the presence of the interruption is determined before the interruption occurs on the received audio signal.

57. The method of claim 31 wherein the presence of the interruption is determined at the time that the interruption occurs on the received audio signal.

58. An apparatus for processing an audio signal in a communications network, the apparatus comprising:
a speech buffer for receiving a first portion of the audio signal over the network from a base station of the network, the speech buffer being configured to store and subsequently output the first portion of the audio signal;
means for determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer;
means for appending a second portion of the audio signal to the first portion in the event that the presence of the interruption has been determined, in such a way as to form an output audio signal having no signal discontinuities in the time domain, the second portion having a predetermined duration and having a pitch matching that of the first portion over the predetermined duration;
means for applying a fade out envelope to the second portion to gradually reduce the amplitude of the second portion over the predetermined duration; and
means for outputting the output audio signal.

59. A system for processing an audio signal, the system comprising:
a communications network comprising a base station for transmitting the audio signal; and
an apparatus for receiving and processing the audio signal, the apparatus comprising:
a speech buffer for receiving a first portion of the audio signal over the network from a base station of the network, the speech buffer being configured to store and subsequently output the first portion of the audio signal;
means for determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer;
means for appending a second portion of the audio signal to the first portion in the event that the presence of the interruption has been determined, in such a way as to form an output audio signal having no signal discontinuities in the time domain, the second portion having a predetermined duration and having a pitch matching that of the first portion over the predetermined duration;
means for applying a fade out envelope to the second portion to gradually reduce the amplitude of the second portion over the predetermined duration; and
means for outputting the output audio signal an apparatus according to claim 28 for receiving and processing the audio signal.

60. A computer program product comprising computer readable instructions stored on a non-transitory computer readable medium for directing the operation of a processor to process an audio signal in a communications network, said process comprising:
receiving, at a speech buffer, a first portion of the audio signal over the network from a base station of the network, the speech buffer being configured to store and subsequently output the first portion of the audio signal;
determining the presence of an interruption to the received audio signal, the interruption being such that a subsequent portion of the audio signal which is intended to be output from the speech buffer immediately following the output of the first portion is not stored in the speech buffer at the time that the subsequent portion is intended to be output from the speech buffer;
in the event that the presence of the interruption has been determined, appending a second portion of the audio signal to the first portion in such a way as to form an output audio signal having no signal discontinuities in the time domain, the second portion having a predetermined duration and having a pitch matching that of the first portion over the predetermined duration;
applying a fade out envelope to the second portion to gradually reduce the amplitude of the second portion over the predetermined duration; and
outputting the output audio signal.
